(19) United States
(12) Patent Application Publication
(10) Pub. No.: US 2016/0347019 A1
(43) Pub. Date: Dec. 1, 2016

(54) Method for Manufacturing a Bag

(71) Applicant: Sirane Limited, Telford (GB)

(72) Inventors: Peter John Longfield, Telford (GB); Ian Shingler, Dudley (GB)

(21) Appl. No.: 15/164,089

(22) Filed: May 25, 2016

(30) Foreign Application Priority Data
May 27, 2015 (GB) 1509070.7

(51) Int. Cl. B31B 23/00; B31B 19/14

(52) U.S. Cl. CPC B31B 23/00; B31B 19/14; B31B 2219/145; B31B 2219/6007; B31B 2237/10; B31B 2237/50

(57) ABSTRACT

A method of manufacturing a bag in which an opening formed in a first web is covered by a second web and the webs are joined forming a continuous seal around a perimeter enclosing the opening and forming an enclosed compartment between the first web and the second web that is accessible through the opening.

### TECHNICAL FIELD

The present invention relates to a method of manufacturing a bag. In particular, but not exclusively, the present invention relates to a method of manufacturing a fluid tight, sealable bag.

### BACKGROUND

There are many situations in which it is desirable to have a fluid (or air) tight bag. For example, such a bag may be used for packaging (e.g. for food, medical devices, hazardous materials etc.) or in cooking (e.g. boil in a bag). In such applications, the bag often needs to be sealed.

It is complex and impractical to form the bag around whatever is held in it. Therefore, bags are formed with an opening, which is sealed once the contents are placed in the bag. Known methods of manufacturing such bags involve joining two sheets together. A slit is provided in one of the sheets, however, the slit extends over the entire length of the bag. This damages the integrity of the seal.

### SUMMARY

According to the invention, there is provided a method for manufacturing a bag, the method comprising: providing a first web; forming an opening through the first web; providing a second web and aligning the second web with the first web in at least one direction, such that the second web overlies the opening; around a perimeter enclosing the opening, sealingly fixing the first web to the second web, such that a continuous seal is provided around the perimeter, forming an enclosed compartment between the first web and the second web, the enclosed compartment being accessible through the opening.

By this invention, there is provided a way of making a bag with a continuous seal around the outside, meaning the bag can form a wholly sealed compartment without any leakage at the edges.

The opening may be of predetermined length. The predetermined length may be less than the dimension of the enclosed compartment measured in the same direction as the direction along which the opening extends.

The web may have a width in a first direction and a length in a second direction, the width of the web being the width of the bag, the length of the web being substantially longer than the length of the bag.

The opening may extend in the second direction, parallel to an edge of the web. The opening may be provided adjacent and spaced from an edge of the web, the spacing arranged to enable a seal to be formed at the edge.

The web may have a width in a first direction and a length in a second direction, the width of the web being the width of the bag, the length of the web being substantially longer than the length of the bag.

The method may further comprise: subsequent to the step of sealingly fixing the first web to the second web, cutting the fixed first and second webs in the first direction to separate the bag from the first and second webs.

The method may further comprise: advancing a first portion of the first web to a first position; holding the first web with the first portion of the first web in the first position and while the first web is held, forming a first opening in the first portion of the first web; advancing the first web and the second web to a second position where the first portion of the first web is aligned with a first portion of the second web, wherein advancing the first portion of the first web to the second position advances a second portion of the first web to the first position; and holding the first web and second web with the first portion of the first and second webs in the second position and the second potion of the first web in the first position and, while the first web and second web are held simultaneously providing an opening in the second portion of the first web, and sealingly fixing the first portion of the first web to the first portion of the second web.

The method may further comprise: advancing the second portion of the first web and a second portion of the second web to the second position, wherein advancing the second portion of the first web to the second position advances a third portion of the first web to the first position.

Advancing a portion of the first web and/or the first and second web may comprise: advancing the portion of the first web and/or the first web and the second web a predetermined distance.

Alternatively, the first web and second web may comprise indicia, the indicia configured to be detected by sensing means, the indicia and sensing means arranged such that when the indicia is detected by the sensing means, respective portions of the first and second webs are aligned at the first and second positions, the method further comprising: for consecutive indicia, detecting the indicia by the sensing means and, in response to detecting the indicia, holding the first and second webs.

Optionally, the method may include the step of, prior to the step of forming an opening, applying sealing means to the first web, the sealing means arranged to be used to seal the opening, in use.

The sealing means may comprise an adhesive layer over at least part of the first web, and a protective layer provided over the adhesive layer, such that, in use, the protective layer can be removed and the adhesive used to fix a covering over the opening, the opening being provided in the at least part of the first web where the adhesive layer is provided. The bag may be constructed and arranged such that the covering may be provided by folding the bag.

The sealing means may be a heat activated sealing means for closing the opening.

The first web and/or the second web may be formed from a material selected from the group comprising: polyamide, polyethylene, polyester, polypropylene and coated paper.

### BRIEF DESCRIPTION OF THE DRAWINGS

The invention will now be described in more detail by way of example only with reference to the accompanying drawings in which:

FIG. 1A illustrates a plan view of a bag made according to the method of embodiments of the invention;

FIG. 1B illustrates a cross-section of the bag of FIG. 1A, through line A;

FIG. 2 schematically illustrates a system for manufacturing a bag in accordance with embodiments of the invention;

FIG. 3A illustrates an example of the first web after openings have been formed in the first web;

FIG. 3B illustrates a plan view after the first web and the second web have been sealingly fixed together; and

FIG. 4 is a flow chart showing a method of manufacturing bags according to an embodiment of the invention.

### DETAILED DESCRIPTION

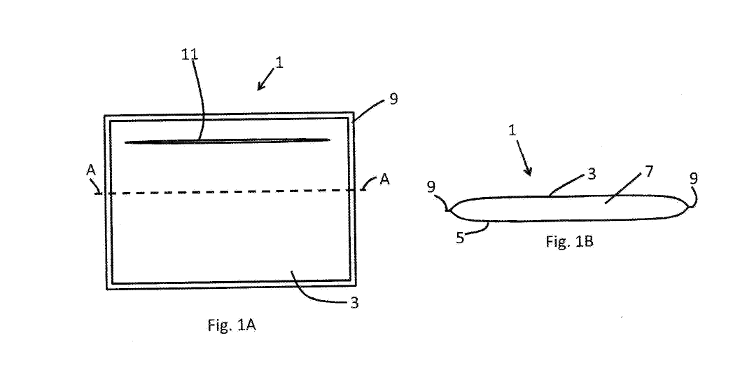

FIGS. 1A and 1B show an example of a bag 1 that can be made by the manufacturing methods disclosed in embodiments of the invention. The bag 1 includes an internal compartment 7 formed between a first sheet of material 3 and a second sheet of material 5. The compartment 7 is formed by overlying the sheets 3, 5 and joining them around the edges, so that a seal 9 is formed.

An opening 11 is provided in the first sheet of material 3, through which the compartment 7 is accessible. As will be discussed in detail below, the opening 11 can be sealed shut. The material of the bag 1, and the seal 9 are such that when the opening 11 is sealed shut, the compartment is sealed from the outside environment.

The bag 1 can be sized for any suitable use. The choice of materials and seal 9 used for the bag 1 is also dependent on the intended use. The seal 9 around the edges of the bag 1 and the seal over the opening 11 may be fluid tight or gas tight, depending on the requirements of the bag 1.

For example, the bag 1 may be made from polyamide, polyethylene, polypropylene, coated paper or polyester. The different properties of these materials will be apparent to the person skilled in the art.

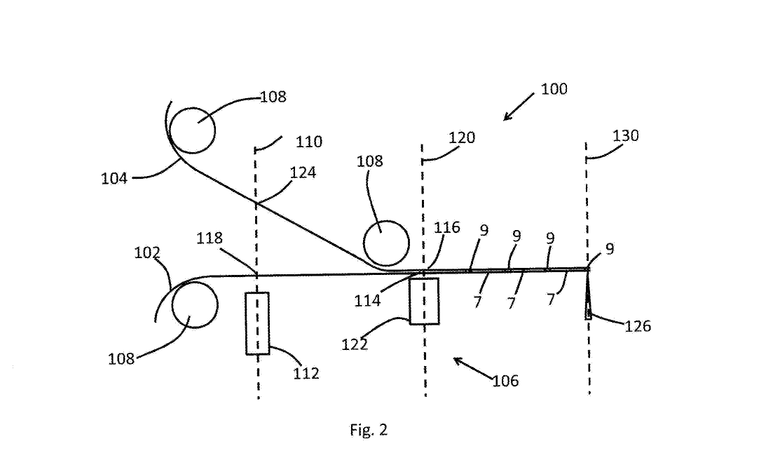

A method 200 of manufacturing the bags 1 shown in FIGS. 1A and 1B will now be described with reference to FIGS. 2 to 4. The method 200 is suitable for manufacturing a single bag 1, although it is readily scalable to many bags 1.

FIG. 2 shows a system 100 for manufacturing bags 1. The system 100 is based on a conveyor or assembly line system.

According to some embodiments of the invention, the material for the first and second sheets 3, 5 is provided as first and second webs 102, 104 respectively. Webs 102, 104 are continuous rolls of material that may be cut to form separate sheets 3, 5.

In one embodiment, each web 102, 104 has the same width as the bags 1 to be made, but is many times longer than the bags 1, so that many bags 1 can be formed from the webs 102, 104. For example, the length of the webs 102, 104 may be suitable for making 10 bags 1, 100 bags 1, 1000 bags 1, or any other number of bags 1. The webs 102, 104 may be considered continuous because they are many orders of magnitude longer than wide.

As shown in FIG. 2, each of the webs 102, 104 is directed along an assembly line 106. Any suitable means can be used to move the webs 102, 104, and such means are already known in the art. In the example shows, rollers, 108 are used.

At a first position 110 in the assembly line 106, there is a cutting means/station 112. The cutting means 112 provides cuts through the first web 102, to form the opening 11.

To produce a plurality of bags 1, the cutting means 112 cuts the first web 102 at regular intervals along the web 102. The cut is sized so that the opening 11 is smaller than the length of the bag 1. The spacing between cuts is sized so that a seal 9 (or seals 9) may be formed in the spacing, without the cut extending into the seal 9.

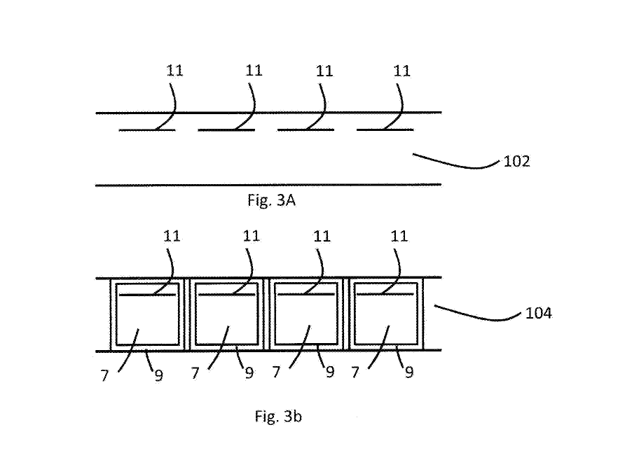

FIG. 3A shows an example of the first web 102 after the cutting station 112.

In some embodiments, the cutting means 112 includes a blade (not shown) of the same length as the opening 11 required, and means for moving the blade. To provide the cut, the blade is moved along an axis perpendicular to the surface of the web 102.

In some of the embodiments, the blade may be shorter than the required opening length, and may also be moved along the direction of the cut to provide an opening 11 of the desired length.

In the example shown in FIG. 3A, the cut is provided close to an edge of the first web 102, and parallel to the edge of the web 102. However, it will be appreciated that the cut may be in any desired position and orientation, provided it is separate from the seal 9 once the seal 9 is formed.

At a second position 120 in the assembly line 106, there is a sealing means/station 122. The sealing means 120 fixes the first web 102 to the second 104 with a sealed joint 9. To form a bag 1, the seal 9 is provided along both edges of the webs 102, 104, and across the width of the webs 102, 104 at two separate locations along the length of the webs 102, 104.

In this way, the seal 9 defines the compartment 7 and forms a perimeter defining the bag 1. As can be seen from FIG. 1A the dimensions of the seals 9 are such that the opening 11 is separated from any of the seals 9.

The seal 9 may be formed by any suitable means. For example, depending on the material used for the webs 102, 104, the seal 9 may be provided by heating, adhesive, or stitching or a combination of these options.

To produce plurality of bags 1, the sealing means 122 forms continuous seals 9 along the edges of the webs 102, 104 and provides seals 9 across the width of the webs 102, 104 at regular intervals.

The assembly line 106 also includes second cutting means 126. The second cutting means 126 separates the bags 1 formed by the assembly line 106, after the seal 9 is formed. The second cutting means 126 may be provided at the second position 120, or at a separate second cutting station at a third position 130.

FIG. 3B shows and example of the first web 102, after the seals 9 have been formed, before the bags 1 are cut at a second cutting means 126. In this example, the second cutting means 126 are provided at a third position 130.

As can be seen, a plurality of compartments 7 are formed, joined by the seals 9 across the width of the webs 102, 104. Therefore, before the bags 1 are separated, each compartment 7 shares the seals 9 across the width of the webs 102, 104 with the neighbouring compartments 7.

In this example, the second cutting means 126 cuts through the seal 9 to form separate bags 1. The seal 9 is wide enough that both compartments 7 formed by seal 9 remain sealed after cutting.

In other examples, a pair of seals 9 may be provided across the width of the webs 102, 104. In these examples, the compartments 7 do not share any seals 9, and the second cutting means 126 provides a cut between the seals 9. In these examples, the seals 9 along the edges of the webs 102, 104 may not be continuous, and may only extend for the length required to form the bag 1.

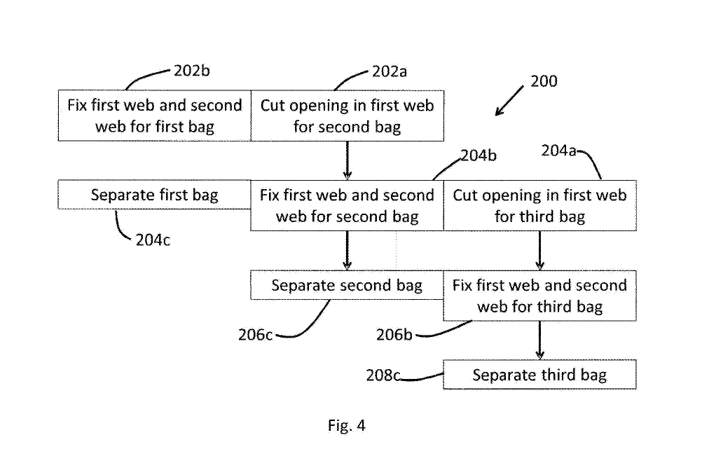

One embodiment of the operation of the assembly line 106 will now be described with reference to FIG. 4. In the below, it will be assumed that the second cutting means 126 is provided at a third position 130.

To start, the first web 102 is advanced by the assembly line 106, so that:
i. A first portion 114 of the first web 102, and a first portion 116 of the second web 104 are at the second position 120 (sealing station 126); and
ii. A second portion 118 of the first web 102 is at the first position 110 (cutting station 112).

The assembly line 106 is then held at this position for a first manufacturing step 202, in which:
i. A cut is provided in the second portion 118 of the first web 102; and
ii. A seal 9 is formed around the edges of the first portions 114, 116 of the first and second webs 102, 104.

Once the seal 9 is formed at the first portions 114, 116, and the opening 11 is formed at the second portion 118, the assembly line 106 is then advanced so that:
i. The joined first portions 114, 116 of the first and second webs 102, 104 are at the second cutting means 126;
ii. The cut second portion 118 of the first web 102 and a second portion 124 of the second web 104 are at the second position 120 (sealing station 126); and
iii. A subsequent portion of the first web 102 is at the first position 110 (cutting station 112).

The assembly line 106 is again held, for a second step 204, in which:
i. A cut is provided in the subsequent portion of the first web 102;
ii. A seal 9 is formed around the edges of the second portions 118, 124 of the first and second webs 102, 104; and
iii. The first portions 114, 116 of the first and second webs 102, 104 are separated from the webs 102, 104 by the second cutting means 126, to form a bag 1.

Once again, the assembly line 106 is advanced, so that:
i. The second portions 118, 124 of the first and second webs 102, 104 are at the second cutting means 126;
ii. The subsequent portion of the first web 102 and a subsequent portion of the second web 104 are at the second position 120 (sealing station 126); and
iii. A further subsequent portion of the first web 102 is at the first position 110.

The assembly line 106 is again held, for a third step 206, in which:
i. A cut is provided in the further subsequent portion of the first web 102;
ii. A seal 9 is formed around the edges of the subsequent portions of the first and second webs 102, 104; and
iii. The second portions 118, 124 of the first and second webs 102, 104 are separated from the webs 102, 104 by the second cutting means 126, to form a second bag 1.

The method then continues in this manner to form further bags 1.

It will be appreciated that although in the above examples, adjacent portions are at adjacent positions 110, 120, 130 of the assembly line 106, this is not necessarily the case and, for example, there may be several portions of the webs 102, 104 between the first 110 and second 120 positions.

It will also be appreciated that if the second cutting means 126 is provided at the second location, any sealing step 202b, 204b, 206b will also include the step to separate the formed bag 204c, 206c.

It will be further appreciated that the assembly line 106 does not necessarily have to be stopped for each of the steps to occur, instead, the cutting means 112, 126 and the sealing means 126 may be moved into and out of engagement as necessary.

In one embodiment, when the assembly line 106 is required to advance the webs 102, 104, the webs 102, 104 are advanced a predetermined distance. The predetermined distance is known from the relative positions of the stations 112, 126 and the sizes of the bags 1 and is the distance required to move the next portion to the respective stations 112, 126.

In other embodiments, the webs 102, 104 may be provided with indicia or markings. The assembly line 106 will be provided with a detector (or detectors), and be calibrated so that when the markings are aligned with the detector(s), the webs 102, 104. When the webs 102, 104 are moved on again, they are stopped when the next marking is aligned with the detector(s).

In other examples, the webs may 102, 104 may move on a number of markings before being held again. Alternatively, the spacing of the markings may be varied.

As mentioned above, at some point in use, it may be necessary to seal the opening 11. The opening 11 may be sealed in any suitable type manner.

In one embodiment, an adhesive may be used. The adhesive may be provided separately, for later application by the user. Alternatively, the adhesive may be applied during the manufacturing process, and then covered with a protective layer. When it is desired to seal the bag 1, the protective layer can be removed, and the adhesive used to seal the opening 11 (e.g. by folding the bag 1 over).

In such embodiments, the adhesive should be provided in the same region as the opening 11. For example, the adhesive and protective layer may be provided continuously along the edge of the first web 102, and the opening 11 may be provided through the first web 102, the adhesive and the protective layer.

In another embodiment, the material of the webs 102, 104 may be able to form a seal upon heat treatment, or a heat activated heating material may be applied to the first web 102 in a similar manner to the adhesive material described above. When the heat activated material is activated, a seal is formed.

It will be understood that the invention is not limited to the embodiment described herein and that features of the method may be altered, omitted or adapted. It will also be understood that the features described with respect to a particular embodiment may be combined with any features described with respect to other embodiments.

I claim:

1. A method for manufacturing a bag, the method comprising: providing a first web; forming an opening through the first web; providing a second web and aligning the second web with the first web in at least one direction, such that the second web overlies the opening; around a perimeter enclosing the opening, sealingly fixing the first web to the second web, such that a continuous seal is provided around the perimeter, forming an enclosed compartment between the first web and the second web, the enclosed compartment being accessible through the opening.

2. The method of claim 1 wherein the opening is of predetermined length.

3. The method of claim 2 wherein the predetermined length is less than the dimension of the enclosed compartment measured in the same direction as the direction along which the opening extends.

4. The method of claim 1 wherein the web has a width in a first direction and a length in a second direction, the width of the web being the width of the bag, the length of the web being substantially longer than the length of the bag.

5. The method of claim 4 wherein the opening extends in the second direction, parallel to an edge of the web.

6. The method of claim 5 wherein the opening is provided adjacent and spaced from an edge of the web, the spacing arranged to enable a seal to be formed at the edge.

7. The method of claim 1 wherein the method further comprises: subsequent to the step of sealingly fixing the first web to the second web, cutting the fixed first and second webs in the first direction to separate the bag from the first and second webs.

8. The method of claim 1 wherein the method further comprises: advancing a first portion of the first web to a first position; holding the first web with the first portion of the first web in the first position and while the first web is held, forming a first opening in the first portion of the first web; advancing the first web and the second web to a second position where the first portion of the first web is aligned with a first portion of the second web, wherein advancing the first portion of the first web to the second position advances a second portion of the first web to the first position; and
holding the first web and second web with the first portion of the first and second webs in the second position and the second potion of the first web in the first position and, while the first web and second web are held simultaneously providing an opening in the second portion of the first web, and sealingly fixing the first portion of the first web to the first portion of the second web.

9. The method of claim 8 wherein the method further comprises: advancing the second portion of the first web and a second portion of the second web to the second position, wherein advancing the second portion of the first web to the second position advances a third portion of the first web to the first position.

10. The method of claim 8 wherein the step of advancing a portion of the first web and/or the first and second web may comprise: advancing the portion of the first web and/or the first web and the second web a predetermined distance.

11. The method of claim 8 wherein the first web and second web may comprise indicia, the indicia configured to be detected by sensing means, the indicia and sensing means arranged such that when the indicia is detected by the sensing means, respective portions of the first and second webs are aligned at the first and second positions, the method further comprising: for consecutive indicia, detecting the indicia by the sensing means and, in response to detecting the indicia, holding the first and second webs.

12. The method of claim 1 wherein the method includes the step of, prior to the step of forming an opening, applying sealing means to the first web, the sealing means arranged to be used to seal the opening, in use.

13. The method of claim 12 wherein the sealing means comprises an adhesive layer over at least part of the first web, and a protective layer provided over the adhesive layer, such that, in use, the protective layer can be removed and the adhesive used to fix a covering over the opening, the opening being provided in the at least part of the first web where the adhesive layer is provided.

14. The method claim 13 wherein the bag is constructed and arranged such that the covering may be provided by folding the bag.

15. The method of claim 12 wherein the sealing means is a heat activated sealing means for closing the opening.

16. The method of claim 1 wherein the first web and/or the second web is formed from a material selected from the group comprising: polyamide, polyethylene, polyester, polypropylene and coated paper.
